(19) United States
(12) Patent Application Publication
(10) Pub. No.: US 2013/0262232 A1
(43) Pub. Date: Oct. 3, 2013

(54) Method for transmitting directed advertisements over the Internet

(71) Applicant: Carl ANDER, DANDERYD (SE)

(72) Inventor: Carl ANDER, DANDERYD (SE)

(73) Assignee: MASTER INVEST AB, STOCKHOLM (SE)

(21) Appl. No.: 13/462,219

(22) Filed: May 2, 2012

(30) Foreign Application Priority Data
Mar. 30, 2012 (SE) 1250317-3

(51) Int. Cl. G06Q 30/02

(52) U.S. Cl. 705/14.64

(57) ABSTRACT

Method for sending advertisement over the Internet, including a main computer system having a central computer and recorded advertisement videos, includes inputting a profile into the central computer for each user wishing to see advertisement, which profile is constituted by the user's replies to specific questions, inputting a categorization of each recorded video into the central computer, which categorization is constituted by one or several choices from a number of predefined options giving information about to whom the advertisement is directed and/or what each respective video is advertising, storing the videos in the central computer or on the Internet, and when a user of a portable personal electronic device requests access to a wireless network connected to the Internet and central computer, causing the central computer to send an offer to the portable device that the user can connect to the wireless network at no charge.

The present invention relates to a method for sending addressed advertisements over the Internet.

It is desirable to be able to send addressed advertisement over the Internet to persons using a portable computer or a smart telephone, a so called smartphone, or a tablet computer which is connected to the Internet.

On various pages on the Internet there is a large prevalence of advertisements or commercials which is of general nature, in other words not addressed to certain persons or to specific target groups, but appearing when a user visits a certain page.

It is previously known to send addressed advertisements to various persons via ordinary mail, where the sender knows which persons to be reached using various registers.

Furthermore, it is known to send addressed advertisement over the Internet as e-mails, for example commercials for renting hotel rooms where the person addressed by the advertisement has stayed at the hotel previously.

However, there is a need to be able to send addressed advertisements via the Internet. In particular, there is a need to be able to send out an addressed advertisement in the form of a short recorded video.

One problem is to reach the person in question at an occasion when the person has the time to watch the video advertisement, and another problem is to get the person to see the whole video advertisement.

The present invention solves these problems.

Hence, the present invention relates to a method for sending addressed advertisement over the Internet, comprising a main w computer system comprising a central computer as well as recorded advertisement videos, and is characterized in that a profile is input into the central computer for each user which wishes to see advertisement, which profile is constituted by the user's replies to a number of specific questions, in that a categorization of each recorded video is input into the central computer by the party desiring to advertise using a recorded video, which categorization is constituted by one or several choices from a number of predefined options giving information about to whom the advertisement is directed and/or what each respective video is advertising, in that the said videos are stored in the central computer or elsewhere on the Internet, in that when a user of a portable personal computer, a smartphone or a tablet computer requests access to a wireless network (WiFi), which is connected to the Internet and which is connected to the said central computer, the central computer is caused to send an offer to the portable personal computer, the smartphone or the tablet computer, comprising that the user can be connected to the wireless network at no charge, in that, provided that the user wishes to gain access to the network, the central computer is caused to pair the said profile to the said categorization, in that the central computer is caused to select at least one video as a result of the said pairing, in that the central computer is caused to send, via the wireless network, to the portable personal computer, the smartphone or the tablet computer, the selected video so that the user can view the video, and in that, when the whole video as been shown, the central computer is caused to connect the portable personal computer, the smartphone or the tablet computer to the wireless network.

Below, the invention is described in closer detail, partly in connection to an exemplary embodiment of the invention shown in the appended drawing, wherein

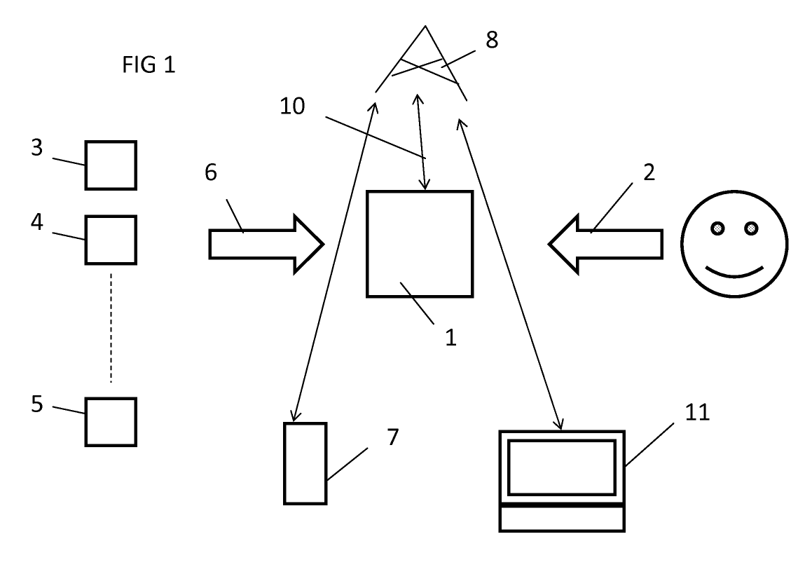

FIG. 1 shows a block diagram of devices for carrying out the invention according to an exemplary embodiment.

The aim of the present method is to send addressed advertisements over the Internet, where a main computer system comprises a central computer as well as recorded commercial videos.

According to the invention, a profile is input into the central computer 1 for each user wishing to view an advertisement, which is illustrated by arrow 2. The profile 2 is constituted by the user's reply to a number of specific questions. In the central computer 1, a categorization of each recorded video 3, 4, 5 is also input, which is illustrated by arrow 6. The categorization is made by the party wishing to advertise using a recorded video 3, 4, 5. The categorization is constituted by one or several choices of a number of predetermined options providing information regarding to whom the advertisement is directed and/or what each respective video is advertising. The said videos are stored in the central computer 1 or elsewhere on the Internet.

When the user of a portable personal computer 11 or a smartphone 7 requests access to a wireless network 8 (WiFi), which is connected to the Internet and to the said central computer 1, the central computer 1 sends an offer to the portable personal computer 11 or the smartphone 7, comprising that the user can be connected to the wireless network 8 at no charge. The offer is displayed as a message on the display of the personal computer 11 or the smartphone 7.

Instead of a wireless network (WiFi), access can be obtained to the network or networks of mobile operators. The central computer is then maintained by the mobile operator.

The wireless network 8 can be a network at a hotel, an airport, a shopping mall or another public space where persons are sitting down using the Internet. Such wireless networks are normally subject to a charge, often with relatively high prices.

Provided that the user wishes to have access to the network 8, the central computer is caused to pair the said profile 2 with the said categorization associated with stored videos 3, 4, 5 such that one or several videos match the stored profile of the user. Thereafter, the central computer 1 is caused to select at least one video as a result of the said pairing.

Thereafter, the central computer 1 is caused to send the selected video 3, 4, 5 to the personal computer 11 or the smartphone 7, via the wireless network 8, so that the user can view the video. Once the whole video has been shown, the central computer 1 connects the portable personal computer 11 or the smartphone 7 or the tablet computer to the Internet via the wireless network 8, after which the user can use the wireless network at no charge.

A suitable length of one or a small number of videos can be 30-60 seconds in total.

Advantageously, the communication between the central computer 1 and the wireless network takes place via a cable, and is illustrated by arrow 10. The communication between the portable personal computer or the smartphone, respectively, and the central computer takes place via the wireless network.

According to a preferred embodiment, the said specific questions comprise three or more of the parameters gender, age, travel destination, interests, profession, type and place of residence, income.

It is apparent that the skilled person can select parameters in relation to expected users desiring to be connected to the wireless network.

It is preferred that the said options comprise options that describe what is suitable for video advertising, such as one or several travel destinations, housing, cars, sporting goods, foodstuffs, medicines, restaurants, hotels, etc. Of course, the skilled person can categorize the said videos more or less specifically.

The said pairing in the central computer 1 is carried out by a suitable algorithm. For example, the said specific questions can be matched with the choices that constitutes the categorization. One of the said specific questions may, for example, be if the user is interested in travel, while travels are one of the possible categorizations of a video.

The invention makes it possible for a buyer of advertisement in a very accurate way to send selected and addressed advertisements to a user which, at the time for the advertisement, with a large probability is in a situation where the user is sitting down or standing still, because the user intends to use the Internet.

According to a preferred embodiment, the central computer is caused to send, to the portable computer or the smartphone and for display thereon, a question if the viewer has viewed the video or videos having been displayed, whereby it is required that the question is answered by the user in order to gain access to the said network.

It is preferred that, when the user for the first time requests access to the wireless network, the central computer is caused to send the said specific questions to the portable personal computer or the smartphone, which questions the user must reply.

When the user logs out from the wireless network 8, the user must again request access to the said network in order to again be connected to the network.

It is also preferred that, when the user has answered the said specific questions, the central computer is caused to send a password to the portable personal computer or the smartphone, and in that when the password is sent to the central computer using the portable personal computer or the smartphone, instead of the user replying the said questions when subsequent access to the wireless network is requested after the said first time, the user gains access to the wireless network. When the password has been sent to the central computer, the said specific questions are activated for the person in question.

Above, a number of embodiments have been described. However, it is apparent that the embodiments can be varied by the skilled person. Therefore, the present invention is not to be regarded as limited to the above described embodiments, but may be varied within the scope of the enclosed claims.

1. Method for sending addressed advertisement over the Internet, comprising a main computer system comprising a central computer as well as recorded advertisement videos, characterized in that a profile (2) is input into the central computer (1) for each user which wishes to see advertisement, which profile is constituted by the user's replies to a number of specific questions, in that a categorization of each recorded video (3,4,5) is input into the central computer (1), which categorization is constituted by one or several choices from a number of predefined options giving information about to whom the advertisement is directed and/or what each respective video is advertising, in that the said videos (3,4,5) are stored in the central computer (1) or elsewhere on the Internet, in that when a user of a portable personal computer (11), a smartphone (7) or a tablet computer requests access to a wireless network (WiFi) (8), which is connected to the Internet and which is connected to the said central computer (1), the central computer is caused to send an offer to the portable personal computer (11) or the smartphone (7), comprising that the user can be connected to the wireless network (8) at no charge, in that, provided that the user wishes to gain access to the network (8), the central computer (1) is caused to pair the said profile to the said categorization, in that the central computer (1) is caused to select at least one video as a result of the said pairing, in that the central computer (1) is caused to send, via the wireless network (8), to the portable personal computer (11), the smartphone (7) or the tablet computer, the selected video so that the user can view the video, and in that, when the whole video as been shown, the central computer (1) is caused to connect the portable personal computer (11), the smartphone (7) or the tablet computer to the wireless network.

2. Method according to claim 1, characterized in that the said specific questions comprise questions about three or more of the parameters gender, age, travel destination, interests, profession, type and place of residence, income.

3. Method according to claim 1, characterized in that the said options comprise options that describe what is suitable for video advertising, such as one or several travel destinations, housing, cars, sporting goods, foodstuffs, medicines, restaurants, hotels, etc.

4. Method according to claim 1, characterized in that, when the user logs out from the wireless network (8), the user must again request access to the said network in order to be reconnected to the network.

5. Method according to claim 1, characterized in that, when the user has been shown the video or the videos which are required in order to be connected to the wireless network (8) at no charge, the central computer (1) is caused to send, to the portable computer (11), the smartphone (7) or the tablet computer and for display thereon, a question if the viewer has seen the video or videos that have been shown, which question then needs to be answered by the user in order to gain access to the said network (8).

6. Method according to claim 1, characterized in that, when the user for the first time requests access to the wireless network (8), the central computer (1) is caused to send the said specific questions to the portable personal computer (11), the smartphone (7) or the tablet computer, which questions the user must reply.

7. Method according to claim 1, characterized in that the central computer (1) is caused to send a password to the portable personal computer (11), the smartphone (7) or the tablet computer when the user has answered the said questions, and in that, when the password is sent to the central computer (1) using the portable personal computer (1), the smartphone (7) or the tablet computer, the user is provided access to the wireless network (8) instead of the user replying to the said specific questions.
